(19) United States
(12) Patent Application Publication
(10) Pub. No.: US 2014/0208755 A1
(43) Pub. Date: Jul. 31, 2014

(54) Gas Turbine Air Mass Flow Measuring System and Methods for Measuring Air Mass Flow in a Gas Turbine Inlet Duct

(71) Applicant: General Electric Company, Schenectady, NY (US)

(72) Inventors: Sanji Ekanayake, Mableton, GA (US); Alston Ilford Scipio, Mableton, GA (US); Rex Allen Morgan, Simpsonville, SC (US); Sascha Schieke, Simpsonville, SC (US); Thomas C. Billheimer, Atlanta, GA (US)

(73) Assignee: General Electric Company, Schenectady, NY (US)

(21) Appl. No.: 14/060,839

(22) Filed: Oct. 23, 2013

Related U.S. Application Data
(63) Continuation-in-part of application No. 13/751,719, filed on Jan. 28, 2013.

(51) Int. Cl. G01M 15/14; F02C 7/00

(52) U.S. Cl. CPC G01M 15/14; F02C 7/00
USPC 60/722; 73/112.01

(57) ABSTRACT

A method and system for measuring a mass flow rate in a portion of a flow path in an inlet duct of a gas turbine engine is provided. The system includes a sensor assembly attached to the inlet duct. The sensor assembly includes a tube with a longitudinal axis disposed in a substantially laminar flow region of the inlet duct, and a flow conditioner disposed in the tube. A hot wire sensor disposed in the tube is also provided.

### CROSS-REFERENCE TO RELATED APPLICATIONS

This application is a continuation-in-part of co-pending application Ser. No. 13/751,719 filed Jan. 28, 2013 entitled SYSTEMS AND METHODS FOR MEASURING A FLOW PROFILE IN A TURBINE ENGINE FLOW PATH and assigned to the same assignee as the present invention.

### BACKGROUND

The subject matter disclosed herein generally relates to instrumentation for turbine engines and more particularly to systems for measuring air mass flow in gas turbine inlet ducts.

Control systems for modern turbine engines measure internal conditions at various positions within the air and the gas flow paths through the turbine engine. Air pressure and temperature measurements may be made through the use of Pitot tubes, thermocouples, and other devices positioned within the compressor and elsewhere. In the absence of suitable hardware, the sensors may be slotted into the compressor or other location on rakes. Rakes are generally mounted onto a machined surface within the compressor and elsewhere.

Currently, compressor inlet volumetric flow measurements are taken using static pressure, together with differential pressure measurements, in the inlet bellmouth of the turbine engine during continual operation. Compressor inlet mass flow calculation from a volumetric flow measurement additionally requires inlet air density derived from the inlet air temperature and relative humidity measurements combined. This method works reasonably well at full load, where the airflow rate is high and fairly stable, but the accuracy of this approach diminishes as the airflow rate is reduced. Below full speed no load, for example, the current method for measuring airflow is known to be inaccurate and is highly variable. In addition, each measurement type has an associated measurement uncertainty, resulting in potentially higher uncertainty than a single measurement. The individual sensors that collectively yield the calculated mass flow also tend to lose calibration over time, resulting in a drift error of the calculated result, and in turn reducing the repeatability of the calculated mass flow over time. Due to this high variability it is difficult to obtain an accurate understanding of compressor airflow over time and, therefore, the utilization of compressor inlet airflow for turbine engine control presents control and diagnostics issues.

Currently, exhaust velocity profiles are measured by utilizing exhaust temperature and total pressure rakes which traverse the exhaust duct. These measurements are then utilized to calculate the exhaust velocity profile utilizing physics based equations. This method works reasonably well for validation testing purposes and is currently applied for the validation of turbine aerodynamic design changes which impact the exhaust flow velocity profile. However, this method requires the installation of two separate sets of rakes increasing the probability of instrument failure during testing. In addition, each measurement type has an associated measurement uncertainty, resulting in potentially higher uncertainty than a single measurement. Other than validation testing for the purpose of validating new turbine aerodynamic airfoil shapes the measurement of exhaust velocity and or mass flow profiles is currently not standard within the industry.

Compressor extraction flow measurements for turbine engine systems are typically calculated by measuring the temperature and pressure drop across an orifice plate. This method works reasonably well at full load, where the airflow rate through the extraction system is high and fairly stable. However, the accuracy of this method diminishes at lower airflow rates, for which the orifice is oversized, resulting in increased inaccuracy at low loads or low flow levels. In addition, the presence of a fixed orifice size in the extraction system limits the functionality of a modulated extraction flow system since at higher flow rates the simple orifice will be the flow limiting component in the extraction flow system.

Accordingly, there is a need for instrumentation for the measurement of exhaust gas mass flow profiles to provide a means of validation and calibration of turbine aerodynamic models, and to validate the mixing of exhaust cooling mechanisms. Additionally there is a need for instrumentation for the measurement of turbine engine compressor inlet flow mass flow profiles to enable the validation of the mixing of inlet conditioning measures. There is also a need for instrumentation to measure flow density through a compressor extraction conduit accurately, to enable active control of the level of compressor extraction mass flow rate.

### BRIEF DESCRIPTION OF THE INVENTION

The disclosure provides a method for measuring turbine engine inlet mass flow rates, exhaust mass flow rates and extraction mass flow rates accurately.

In accordance with one exemplary non-limiting embodiment, the invention relates to a system for measuring a gas mass flow in a portion of a flow path in a turbine engine. A mass flow sensor assembly having one or more hot wire mass flow sensors is disposed in the portion of the flow path at a location where the flow profile is to be measured. The system also includes a controller that converts signals from one or more of the hot wire mass flow sensors to mass flow measurements.

In another embodiment, a method for measuring a flow profile in a portion of a flow path of a turbine engine is provided. The method further includes sensing a physical change in a plurality of wires disposed in the portion of the flow path of the turbine engine, the physical change being related to a flow attribute at each of a plurality of locations in the portion of the flow path. The method further includes converting signals from the plurality of wires into a flow profile measurement.

In another embodiment, a turbine engine is provided. The turbine engine includes a compressor, a combustor, and a turbine. The compressor, the combustor and the turbine define a flow path. A mass flow sensor assembly is disposed in the flow path. The mass flow sensor assembly is provided with one or more hot wire mass flow sensors. The turbine engine further includes a controller that converts signals from the one or more hot wire mass flow sensors to flow profile measurements.

In another embodiment, a system for measuring a mass flow in an inlet duct of a turbine engine is provided. The system includes a sensor assembly attached to the inlet duct. The sensor assembly includes a tube with a longitudinal axis disposed in a substantially laminar flow region of the inlet duct, a flow conditioner disposed in the tube, and a hot wire sensor disposed in the tube.

In another embodiment, a method for measuring a mass flow in a flow path of an inlet duct of a turbine engine is provided. The method includes the steps of passing a portion of the mass flow through a tube aligned in a direction of the mass flow and conditioning the mass flow in the tube to provide a conditioned mass flow. A wire is exposed to the conditioned mass flow, and a physical change in the wire is sensed. The physical change is converted to a signal, and the signal is converted into a flow measurement.

In another embodiment, a turbine engine having an inlet duct that defines a flow path for an air flow, a compressor, a combustor and a turbine is provided. The turbine engine includes a sensor assembly disposed in the inlet duct. The sensor assembly includes a tube adapted to entrain a portion of the air flow and a hot wire sensor disposed inside the tube. A flow conditioner disposed in the tube upstream from the hot wire sensor is also provided. A controller converts signals from the hot wire sensor to mass flow measurements.

### BRIEF DESCRIPTION OF THE DRAWINGS

Other features and advantages of the present invention will be apparent from the following more detailed description of the preferred embodiment, taken in conjunction with the accompanying drawings which illustrate, by way of example, the principles of certain aspects of the invention.

FIG. 1 is a schematic illustration of an exemplary turbine engine system with flow profile measurement systems.

FIG. 2 is a schematic diagram of an exemplary flow profile measurement system.

FIG. 3 is a schematic diagram of an exemplary calibration system for a flow profile measurement system.

FIG. 4 is a schematic illustration of an embodiment of an inlet plenum flow profile measurement system.

FIG. 5 is a flow diagram of an exemplary method of operating a turbine engine based on a compressor inlet flow profile.

FIG. 6 is a schematic illustration of an embodiment of an exhaust flow profile measurement system.

FIG. 7 is a flow diagram of an exemplary method for operating a turbine engine based on calculated fuel mass flow rate.

FIG. 8 is a schematic illustration of an embodiment of an extraction flow profile measurement system.

FIG. 9 is a cross section across section AA in FIG. 9.

FIG. 10 is a flow diagram of an exemplary method for operating a turbine engine based on calculated extraction mass flow.

FIG. 11 is a schematic illustration of a mass flow profile measurement system.

FIG. 12 is a schematic illustration of a parallel vanes flow conditioner.

FIG. 13 is a schematic illustration of a honeycomb conditioner.

FIG. 14 is a schematic illustration of a tubular flow conditioner.

FIG. 15 is a schematic illustration of an embodiment of an inlet plenum mass flow measuring system.

### DETAILED DESCRIPTION OF THE INVENTION

Embodiments of the present invention provide for the direct measurement of flow profiles in a turbine engine system. In one embodiment, the flow profile at the inlet plenum of a compressor is measured using a rake with a plurality of hot wire mass flow sensors. In another embodiment, the flow profile at the inlet plenum of a compressor may be measured with a plurality of radially positioned hot wire mass flow sensors. In another embodiment, the flow profile at the inlet plenum of a compressor may be closely approximated with a single hot wire mass flow sensor equipped with a flow conditioner. The flow profile may be used to operate the turbine engine system by controlling the mass flow of the compressor. In another embodiment, the flow profile at the exhaust inlet to a turbine may be measured with a rake having a plurality of hot wire mass flow sensors. The exhaust flow profile may be used to operate the turbine engine system based on calculated fuel mass flow rate derived from the measured exhaust flow profile. In another embodiment, the flow profile at a compressor extraction conduit may be measured with a grid of hot wire mass flow sensors. The measured flow profile may be used to operate the turbine engine system based on calculated extraction mass flow. In another embodiment, a sensor assembly having a tube with a flow conditioner disposed in a substantially laminar flow region of the inlet duct is provided. A hot wire sensor is disposed in the tube. The embodiment has the technical effect of conditioning the flow for more accurate and repeatable measurements of the mass flow.

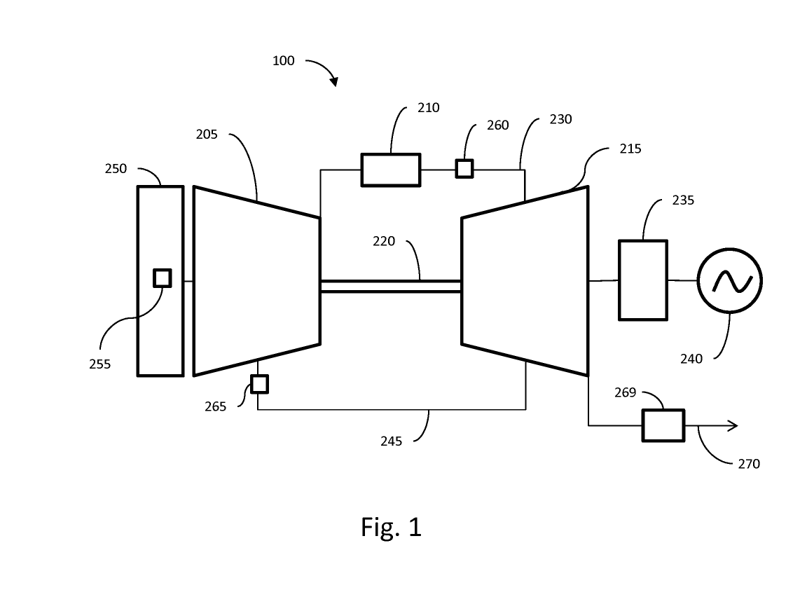

FIG. 1 illustrates a schematic view of an example turbine engine system 100 in accordance with an embodiment of the invention. The turbine engine system 100 includes a compressor 205, a combustor 210 and a turbine 215. Turbine 215 is coupled to a shaft 220 connecting the compressor 205 and turbine 215. In the embodiment shown in FIG. 1, the compressor 205 compresses and discharges gas, and the combustor 210 receives the compressed gas to initiate a combustion process. Combustion gases from the combustor 210 are conveyed through a turbine nozzle 230 to drive the turbine 215, which turns the shaft 220 to drive a generator 235. The generator 235, in turn, generates power for output to an electric grid 240. In the embodiment shown in FIG. 1, air from the compressor 205 can be extracted from one or more stages associated with the compressor 205 through an extraction conduit 245 and can be conveyed to one or more portions of the turbine 215, where the air can cool relatively hot gas path components associated with the turbine 215. The turbine engine system 100 may also include an inlet plenum 250 coupled to the compressor 205. An inlet plenum flow profile measurement system 255 may be coupled to the inlet plenum 250. A combustor exhaust gas flow profile measurement system 260 may be coupled to the turbine nozzle 230. An extraction flow profile measurement system 265 may also be disposed in the extraction conduit 245. A turbine exhaust flow profile measurement system 269 may be disposed in the turbine exhaust duct 270. The inlet plenum 250, the extraction conduit 245, the turbine nozzle 230 and the turbine exhaust duct 270, define flow paths through which gasses with specific flow profiles are conveyed.

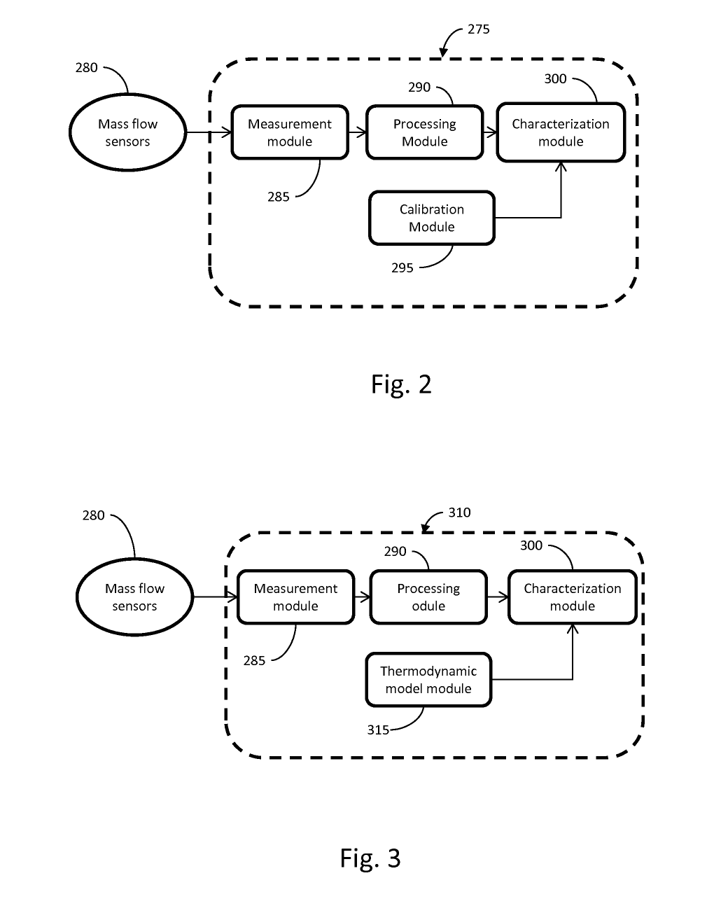

FIG. 2 is a schematic diagram of an embodiment of a flow profile measurement system 275 which may be utilized to measure the mass flow profile and the velocity flow profile in a flow path. The flow profile measurement system 275 may be implemented as an inlet plenum flow profile measurement system 255 (disposed in the compressor inlet flow path), a combustor exhaust gas flow profile measurement system 260 (disposed in the exhaust flow path), or an extraction flow profile measurement system 265 (disposed in the extraction flow path). The flow profile measurement system 275 receives inputs (mass flow profile measurements, or velocity flow profile measurements) from a plurality of mass flow sensors 280. The flow profile measurement system 275 includes a measurement module 285, a processing module 290, a calibration module 295 and a characterization module 300. The function of the measurement module 285 is to aggregate the plurality of mass flow sensor measurements. The function of the processing module 290 is to filter and condition the aggregated mass flow measurements. The function of the calibration module 295 is to provide calibration data that can be applied by the characterization module 300. The characterization module 300 characterizes the data and provides a flow profile output. The inputs from the plurality of mass flow sensors 280 are communicated to the measurement module 285 which in turn conveys the measured sensor values to the processing module 290. The processing module 290 utilizes model based controls and signal filtration techniques such as Kalman filters to process measured current. The model-based controls are derived from a predictive model of the thermodynamic response of the gas turbine. One approach to modeling is using a numerical process known as system identification. System identification involves acquiring data from a system and then numerically analyzing stimulus and response data to estimate the parameters of the system. The processing module 290 may utilize parameter identification techniques such as Kalman filtering, tracking filtering, regression mapping, neural mapping, inverse modeling techniques, or a combination thereof, to identify shifts in the data. The filtering may be performed by a modified Kalman filter, an extended Kalman filter, or other filtering algorithm or, alternatively, the filtering may be performed by other forms of square (n-inputs, n-outputs) or non-square (n-input, m-outputs) regulators. The flow profile measurement system 275 also includes a calibration module 295 that provides calibration data to a characterization module 300 that characterizes the flow profile.

FIG. 3 is a schematic diagram of an embodiment of a flow profile calibration system 310 for a flow profile measurement system 275. The flow profile calibration system 310 receives inputs from a plurality of mass flow sensors 280. The inputs are received in the measurement module 285 which in turn conveys the measured sensor values to the processing module 290. The flow profile calibration system 310 also includes a thermodynamic model module 315 that provides an input to the characterization module 300. The thermodynamic model module 315 may utilize an adaptive real time engine simulation model that may electronically model, in real time, several operating parameters of turbine engine system 100. The function of the thermodynamic model module is to predict the thermodynamic response of the gas turbine.

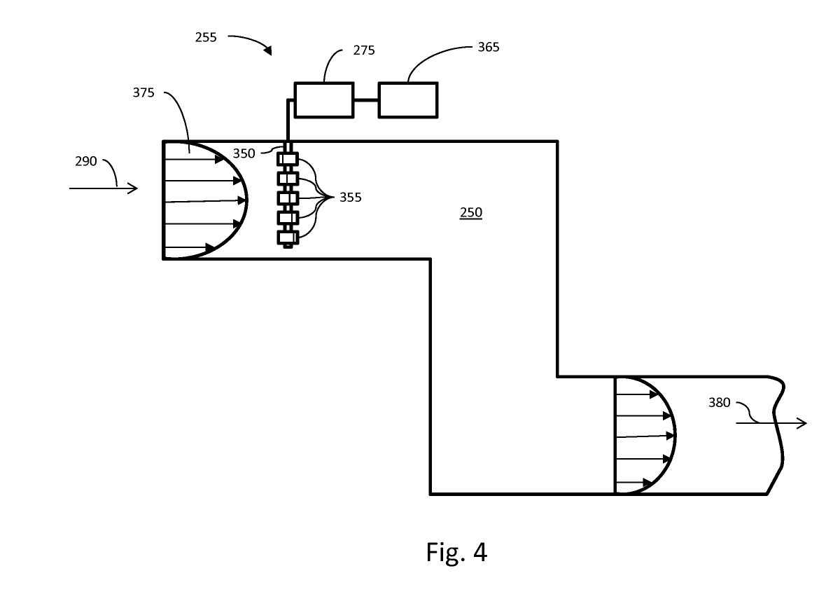

Illustrated in FIG. 4 is an inlet plenum flow profile measurement system 255. The inlet plenum flow profile measurement system 255 includes a mass flow sensor assembly having a rake 350 and a plurality of mass flow sensors such as hot wire mass flow sensors 355 disposed on the rake 350. The rake 350 is configured and positioned to traverse a region of interest, in this case the inlet plenum 250. To traverse the region of interest, the rake 350 may distribute the hot wire mass flow sensors 355 at varying distances along the rake 350. In another embodiment, the flow profile at the inlet plenum 250 of a compressor 205 (shown in FIG. 1) may be measured with a plurality of hot wire mass flow sensors 355 that are positioned radially. The output of the plurality of hot wire mass flow sensors 355 are provided to the flow profile measurement system 275 which may be integrated with or form part of a turbine engine control system 365. Flow into the inlet plenum 250 (represented by arrow 370, the compressor inlet flow path) passes through the plurality of hot wire mass flow sensors 355 where the flow profile 375 is measured and continues to the compressor (represented by arrow 376).

The turbine engine control system 365 may be a conventional SPEEDTRONIC™ Mark VI™ Gas Turbine Control System produced by the General Electric Company. The SPEEDTRONIC™ controller monitors various sensors and other instruments associated with a turbine engine. In addition to controlling certain turbine functions, such as fuel flow rate, the SPEEDTRONIC™ controller generates data from its turbine sensors and presents that data for display to the turbine operator. The data may be displayed using software that generates data charts and other data presentations, such as the CIMPLICITY™ human machine interface (HMI) software product produced by the General Electric Company.

The SPEEDTRONIC™ control system is a computer system that includes microprocessors. The microprocessors execute programs to control the operation of the turbine engine using sensor inputs and instructions from human operators. The control system includes logic units, such as sample and hold, summation and difference units that may be implemented in software or by hardwire logic circuits. The commands generated by the control system processors cause actuators on the turbine engine to, for example, adjust the fuel control system that supplies fuel to the combustion chamber, set the inlet guide vanes to the compressor 205, and adjust other control settings on the turbine engine.

The turbine engine control system 365 includes computer processors and data storage that convert the sensor readings to data using various algorithms executed by the processors. The data generated by the algorithms are indicative of various operating conditions of the turbine engine. The data may be presented on operator displays 22, such as a computer work station, that is electronically coupled to the operator display. The display and or controller may generate data displays and data printouts using software, such as the CIMPLICITY™ data monitoring and control software application.

Hot wire mass flow sensors 355 determine the mass of air or gas flowing into a system. The theory of operation of the hot wire mass flow sensors 355 is similar to that of the hot wire anemometer (which determines air velocity). The mass flow sensor operates by heating a wire with an electric current that is suspended in the gas stream. The wire's electrical resistance increases as the wire's temperature increases, which limits electrical current flowing through the circuit. When gas flows past the wire, the wire cools, decreasing its resistance, which in turn allows more current to flow through the circuit. As more current flows, the wire's temperature increases until the resistance reaches equilibrium again. The amount of current required to maintain the wire's temperature is proportional to the mass of air flowing past the wire. If air density increases due to pressure increase or temperature drop, but the air volume remains constant, the denser air will remove more heat from the wire indicating a higher mass airflow. Unlike the hot wire anemometer, the hot wire mass flow meter responds directly to air density.

An alternative embodiment utilizes a resistive metal film in the form of a plate, which is aligned parallel to the direction of the flow. The flow facing side of the plate, (i.e. the narrow side) is coated with a heat insulating material such that the resistive metal plate of the mass flow sensor is not impacted by any deposits to the leading edge of the rake. This alternate embodiment reduces the impact of material being deposited on the resistive material and, therefore, the need for frequent calibration during continuous operation.

From a performance modeling standpoint, the measurement of compressor inlet mass flow rate profiles provides a means of calculating the average compressor inlet mass flow rate. The average compressor inlet mass flow rate can then be communicated to the turbine engine control system 365 for the control of various turbine engine operating modes. An accurate understanding of compressor inlet flow in conjunction with an accurate understanding of turbine engine exhaust conditions can be utilized to set the overall performance level of a turbine engine through a Model Based Control strategy. In addition, accurate understanding of compressor inlet flow can be utilized to more accurately control the fuel/air ratio for the combustion process within a turbine engine, thus allowing for operation in close proximity to combustion limits such as lean blow out.

From a mechanical stand point the measurement of compressor inlet flow velocity and/or mass flow profiles provides the ability to validate the mixing of inlet conditioning measures. An example would be the injection of Inlet Bleed Heat for compressor surge protection. Locating the compressor inlet flow rake(s) downstream of the inlet bleed heat injection port will provide the ability to quantify the amount of inlet bleed heat injected, relative to a basis with no inlet bleed heat, in addition to the ability to quantify the mixing of inlet bleed heat within the flow stream prior to injection into the compressor. This methodology could be expanded to quantify the amount and mixing of other inlet conditioning measures such as injection of water vapor for power augmentation (i.e. wet compression, etc.).

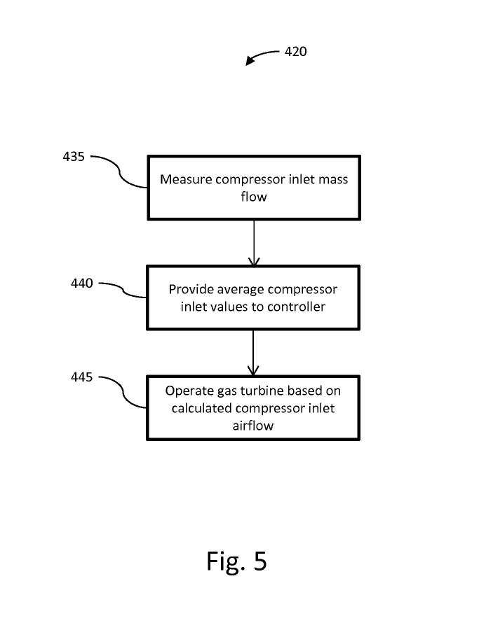

Illustrated in FIG. 5 is a flowchart for a method 420 for operating a turbine engine system based on compressor inlet flow profile.

In step 435 the method 420 measures the compressor inlet mass air flow using the inlet flow mass flow sensors.

In step 440 the method 420 provides the average compressor inlet mass flow value to a turbine engine control system 365.

In step 445 the method 420 operates the turbine engine system based on calculated compressor inlet airflow.

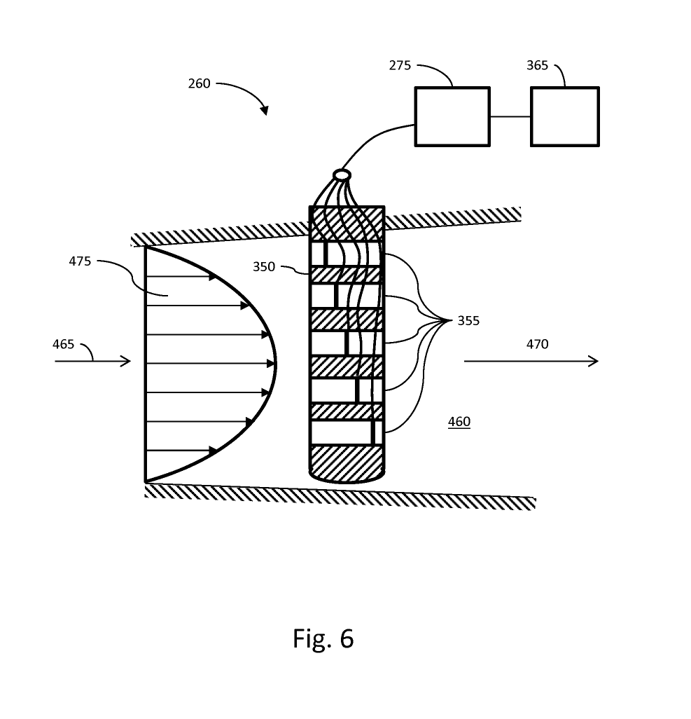

Illustrated in FIG. 6 is a combustor exhaust gas flow profile measurement system 260. A rake 350 with a plurality of hot wire mass flow sensors 355 is disposed in the exhaust gas path 460. Exhaust gasses (denoted by arrow 465) from the combustor 210 (shown in FIG. 1) flow through the plurality of hot wire mass flow sensors 355 and the exhaust gasses (denoted by arrow 470) continue to the turbine 215 (shown in FIG. 1). The output of the plurality of hot wire mass flow sensors 355 is communicated to the flow profile measurement system 275 which may be integrated with or form part of a turbine engine control system 365. The plurality of hot wire mass flow sensors 355 measure the exhaust gas flow profile 475. The measurement of exhaust gas velocity and/or mass flow profiles offers numerous benefits with regards to mechanical and performance modeling. From a mechanical standpoint, the measurement of exhaust gas velocity profiles provides a means of validation and calibration of turbine aerodynamic models. In addition, the measurement of exhaust gas mass flow profiles provides the ability to validate the mixing of exhaust cooling mechanisms (e.g. exhaust frame blower cooling). From a performance modeling standpoint, the measurement of exhaust gas mass flow rate provides a means of calculating the average exhaust gas mass flow rate. The average exhaust gas mass flow rate can then be utilized to isolate either the compressor inlet air flow rate, fuel flow rate and/or frame blower flow rate, with appropriate understanding of two of the three variables, thus improving overall modeling of the exhaust system. In the case of known compressor inlet flow and frame blower flow, the resulting average exhaust gas mass flow rate could be utilized to calculate the fuel mass flow rate into the turbine engine, one of the least accurate measurements in the turbine engine system. This calculated fuel mass flow rate may then be communicated to the turbine engine control system 365 to either control the turbine engine or tune the fuel mass flow being received from the fuel mass flow measuring device.

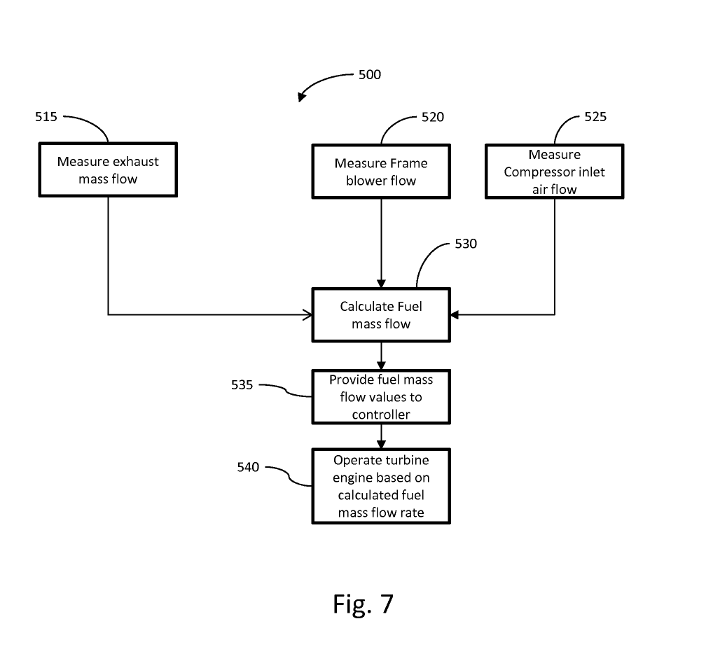

Illustrated in FIG. 7 is a flowchart for a method 500 for operating a turbine engine based on calculated fuel mass flow rate.

In step 515, the method 500 calculates the average exhaust mass flow.

In step 520, the method 500 measures the main blower flow.

In step 525, the method 500 measures the compressor inlet airflow.

In step 530, the method 500 calculates the fuel mass flow from the average exhaust mass flow, the compressor inlet airflow, and the frame blower airflow.

In step 535, the method 500 provides the fuel mass flow values to the turbine engine control system 365.

In step 540, the method 500 operates the turbine based on the calculated fuel mass flow rate.

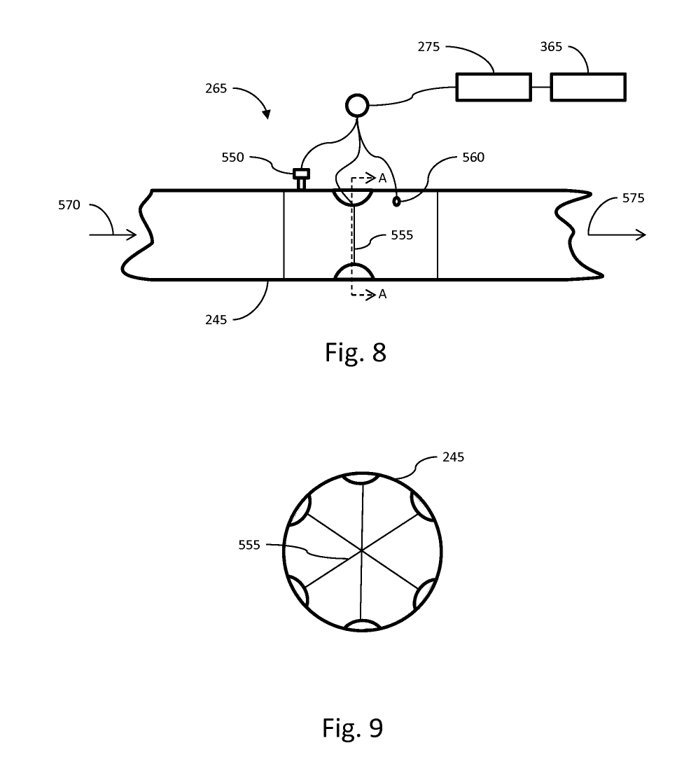

Illustrated in FIG. 8 is an extraction flow profile measurement system 265, and illustrated in FIG. 9 is a cross section along lines AA in FIG. 8. The extraction flow profile measurement system 265 includes a hot wire mass flow sensor grid 555, and may include a thermocouple 560 a pressure transducer 550 and flow profile measurement system 275. The extraction flow profile measurement system 265 measures the flow profile of air flow (denoted by arrow 570) flowing through an extraction conduit 245. Airflow (denoted by arrow 570) is extracted from the compressor 205 (shown in FIG. 1) and may be conveyed (as denoted by arrow 575) to the turbine 215 (shown in FIG. 1). The flow profile measurement system 275 may calculate an average compressor extraction mass flow rate that may then be communicated to a turbine engine control system 365. The calculated average compressor extraction mass flow rate provides the ability to control actively the level of compressor extraction mass flow rate via a metering device, such as a valve located in the compressor extraction system, to predefined operating limits within the turbine engine. The ability to control actively the overall compressor extraction system to operational limits provides numerous performance and maintainability benefits to the combustion engine system. These benefits include cooling flow optimization for performance capability; cooling flow optimization for emissions compliance; cooling flow optimization for improved part-life management; and the ability to control margin to compressor surge or stall.

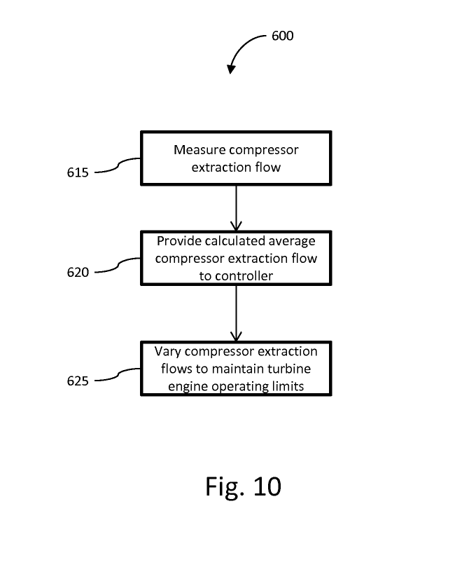

FIG. 10 shows a flowchart for a method 600 for varying extraction flows to maintain turbine engine operating limits based on the flow profile in an extraction conduit 245.

In step 615, the method 600 calculates an average compressor extraction flow.

In step 620, the method 600 provides the calculated average compressor extraction flow value to the turbine engine control system 365.

In step 625, the method 600 varies the compressor extraction flows to maintain turbine engine operating limits.

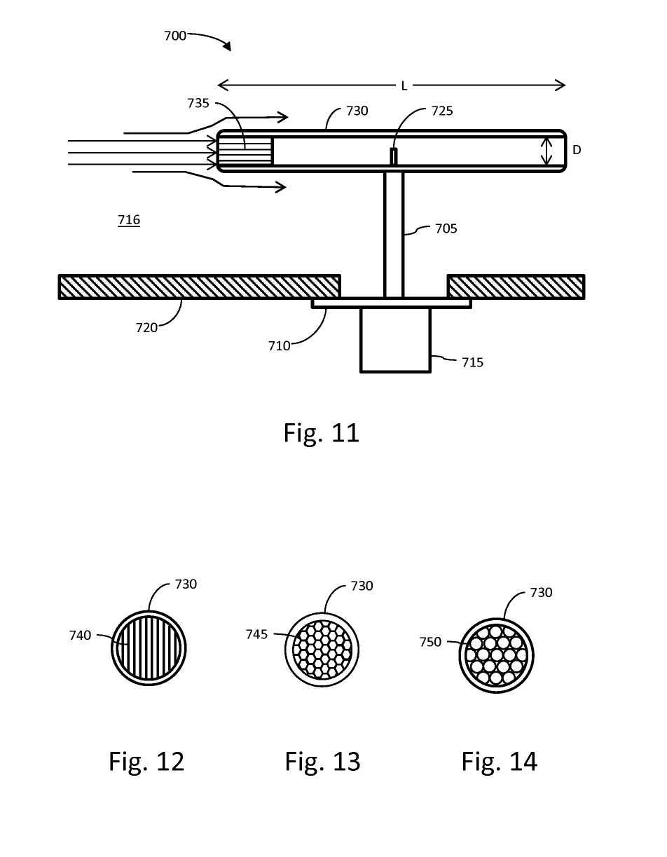

FIG. 11 illustrates another embodiment of a mass flow measuring system 700. The mass flow measuring system 700 is provided with a support member 705 and a mounting flange 710. A transmitter body 715 is provided to transmit data from the mass flow measuring system 700. The mass flow measuring system 700 is disposed in the inlet duct 716 and mounted on an inlet duct wall 720 and secured with the mounting flange 710. The mass flow measuring system 700 also includes a mass flow sensor element 725, such as a hot wire sensor. The mass flow measuring system 700 also includes a straightener tube 730 which may be tubular. The straightener tube 730 may have a circular cross section, or cross sections other than circular. The straightener tube 730 may have an internal diameter D and a length L. The length L may be a function of D. The length L may have a range where L is sufficiently long relative to D so as to eliminate swirl and other undesirable flow characteristics, and sufficiently short so as to avoid stresses that may damage the mass flow measuring system 700.

The straightener tube 730 may be provided with a flow conditioner 735 adapted to reduce swirl and turbulence of the flow. The flow conditioner 735 may have various configurations. For example, FIG. 12 illustrates a parallel vane flow conditioner 740; FIG. 13 illustrates a honeycomb flow conditioner 745; and FIG. 14 illustrates a tubular flow conditioner 750. Although only three configurations are disclosed, it would be apparent to one of ordinary skill that other configurations are also contemplated. The length L of the straightener tube 730 may also be a function of the flow conditioner 735. In general, the straightener tube 730 length L requirement is reduced when equipped with a flow conditioner 735.

In operation, a portion of the mass flow flows through the straightener tube 730 that is aligned in the direction of the mass flow. The straightener tube 730 and the flow conditioner 735 condition the portion of the mass flow by reducing the swirl and turbulence of the air flow. A wire is exposed to the conditioned portion of the mass flow, and a physical change in the wire is sensed. A signal is generated based on the physical change, and the signal is converted into a flow measurement.

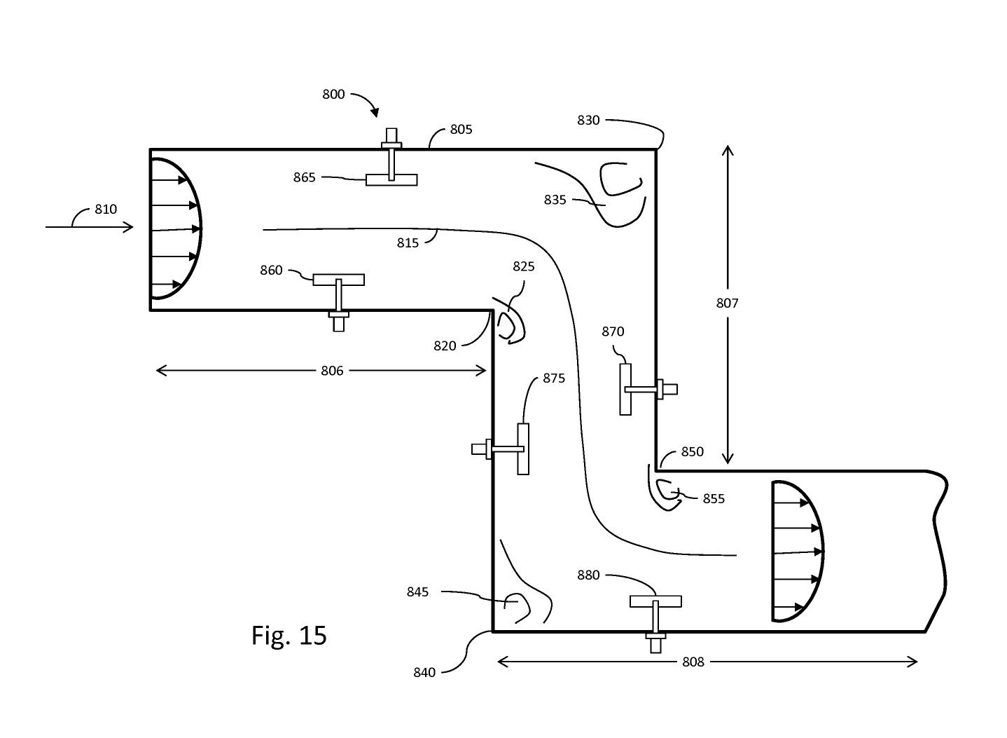

FIG. 15 is a schematic illustration of an embodiment of an inlet plenum mass flow measuring system 800. As shown in FIG. 15 an inlet duct 805 may include a first duct segment 806, a second duct segment 807 and a third duct segment 808. Inlet air 810 flows into the inlet duct 805 and defines a substantially laminar flow path 815. The first duct segment 806 and the second duct segment 807 define a first transition point 820 which defines a first turbulent flow region 825. The first duct segment 806 and the second duct segment 807 also define a second transition point 830 which in turn defines a second turbulent flow region 835. The second duct segment 807 and the third duct segment 808 define a third transition point 840 with a third turbulent flow region 845, and a fourth transition point 850, with a fourth turbulent flow region 855.

The inlet plenum mass flow measuring system 800 is provided with a first air mass flow measuring system 860 and a second air mass flow measuring system 865 disposed in the substantially laminar flow path 815 of the first duct segment 806. A third air mass flow measuring system 870 and a fourth air mass flow measuring system 875 may be disposed in the substantially laminar flow region of the second duct segment 807. A fifth air mass flow measuring system 880 may be disposed in the substantially laminar flow region of the third duct segment 808. Although in this example, five air mass flow measuring systems are described, the inlet plenum mass flow measuring system 800 may be limited to a single air mass flow measuring system such as first air mass flow measuring system 860.

In operation, a plurality of mass flow measuring systems such as first air mass flow measuring system 860, second air mass flow measuring system 865, third air mass flow measuring system 870, fourth air mass flow measuring system 875, and fifth air mass flow measuring system 880 are disposed in the substantially laminar flow path 815 to provide air mass flow readings at different locations of the inlet duct 805. To measure the mass flow accurately, the flow profile of the fluid entering the first air mass flow measuring system 860 must be substantially stable, non-rotating, and symmetric. This type of velocity distribution is known as a fully developed flow profile, and it forms naturally in very long lengths of uninterrupted straight pipe. However, the transition points such as first transition point 820, second transition point 830, third transition point 840 and fourth transition point 850 distort the flow profile into an asymmetric, unstable, and distorted configuration. This makes it difficult to measure the mass flow rate in an accurate and repeatable manner. Under these conditions, the combination of the straightener tube 730 and the flow conditioner 735 are needed to correct the flow profile of the fluid such that it forms a fully developed flow profile which allows accurate and repeatable measurements to be made. The combination of the straightener tube 730 and the flow conditioner 735 reduce the swirl, turbulence and other fluid flow characteristics which will cause errors in the reading from the mass flow sensor element 725.

The terminology used herein is for the purpose of describing particular embodiments only and is not intended to be limiting of the invention. Where the definition of terms departs from the commonly used meaning of the term, applicant intends to utilize the definitions provided herein, unless specifically indicated. The singular forms “a”, “an” and “the” intended to include the plural forms as well, unless the context clearly indicates otherwise. It will be understood that, although the terms first, second, etc., may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling. For all of the embodiments described above, the steps of the methods need not be performed sequentially.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements.

What is claimed:

1. A system for measuring a mass flow in an inlet duct of a turbine engine, comprising:
a sensor assembly attached to the inlet duct, the sensor assembly comprising:
a tube with a longitudinal axis disposed in a substantially laminar flow region of the inlet duct;
a flow conditioner disposed in the tube; and
a hot wire sensor disposed in the tube.

2. The system for measuring a mass flow of claim 1, wherein the longitudinal axis is aligned with a direction of the mass flow.

3. The system for measuring a mass flow of claim 2, wherein the tube has a length long enough to enable conditioning of the mass flow and short enough to avoid stress damage to the sensor assembly.

4. The system for measuring a mass flow of claim 1, wherein the flow conditioner comprises a plurality of parallel vanes.

5. The system for measuring a mass flow of claim 1, wherein the flow conditioner comprises a honeycomb structure.

6. The system for measuring a mass flow of claim 1, wherein the flow conditioner comprised a plurality of parallel tubes.

7. The system for measuring a mass flow of claim 1, further comprising a second sensor assembly disposed in a second substantially laminar flow region of the inlet duct.

8. A method for measuring a mass flow in a flow path of an inlet duct of a turbine engine, the method comprising;
passing a portion of the mass flow through a tube aligned in a direction of the mass flow;
conditioning the mass flow in the tube to provide a conditioned mass flow;
exposing a wire to the conditioned mass flow;
sensing a physical change in the wire generating a signal based on the physical change; and
converting the signal into a flow measurement.

9. The method of claim 8, wherein conditioning the mass flow comprises reducing swirl in the portion of the mass flow.

10. The method of claim 8, wherein conditioning the mass flow comprises reducing turbulence in the portion of the mass flow.

11. The method of claim 8, wherein conditioning the mass flow comprises conveying a portion of the mass flow through an insert with parallel vanes.

12. The method of claim 8 wherein conditioning the mass flow comprises conveying a portion of the mass flow through an insert with a honeycomb structure.

13. The method of claim 8 wherein conditioning the mass flow comprises conveying a portion of the mass flow through an insert with parallel tubes.

14. The method of claim 8 wherein passing a portion of the mass flow through a tube comprises passing a portion of the mass flow through a tube long enough to enable conditioning of the portion of the mass flow though the tube.

15. A turbine engine comprising:
an inlet duct that defines a flow path for an air flow;
a compressor;
a combustor;
a turbine;
a sensor assembly disposed in the inlet duct, the sensor assembly comprising:
a tube adapted to entrain a portion of the air flow;
a hot wire sensor disposed inside the tube; and
a flow conditioner disposed in the tube upstream from the hot wire sensor; and
a controller that converts signals from the hot wire sensor to mass flow measurements.

16. The turbine engine of claim 15, wherein the tube has a diameter and a length relative to the diameter that is long enough to enable conditioning of the portion of the mass flow.

17. The turbine engine of claim 15, wherein the tube has a diameter and a length relative to the diameter that is short enough to prevent stress damage to the sensor assembly.

18. The turbine engine of claim 15, wherein the flow conditioner comprises an insert adapted to reduce swirl and turbulence.

19. The turbine engine of claim 15, wherein the sensor assembly is disposed in a substantially laminar flow region of the inlet duct.

20. The turbine engine of claim 16, further comprising a second sensor assembly disposed in the inlet duct.
